(19) United States
(12) Patent Application Publication
(10) Pub. No.: US 2026/0061451 A1
(43) Pub. Date: Mar. 5, 2026

(54) INJECTION FITTING

(71) Applicant: Calston Group Ltd, Calgary (CA)

(72) Inventors: Joseph Thomas Pirkl, Spring, TX (US); Alanna Elaine DaBreo, Calgary (CA); Lee Alexander Krywitsky, Calgary (CA)

(21) Appl. No.: 19/309,940

(22) Filed: Aug. 26, 2025

Related U.S. Application Data
(60) Provisional application No. 63/687,872, filed on Aug. 28, 2024.

(51) Int. Cl. B05C 5/02

(52) U.S. Cl. CPC B05C 5/0225

(57) ABSTRACT

An injection fitting includes a main body, a flow cylinder, a sealing element, and biasing element. The main body has a fluid passageway therethrough. The flow cylinder is configured to be selectively secured at least partially within the fluid passageway in the main body. The flow cylinder has a fluid passageway therethrough and one or more flow enhancement features. The sealing element is configured to selectively seal off the fluid passageway in the main body and is movable between a sealing position and an open position. The biasing element is configured to bias the sealing element towards the sealing position

### CROSS-REFERENCE TO RELATED APPLICATIONS

This application claims priority to and the benefit of U.S. Patent Application No. 63/687,872, filed Aug. 28, 2024, and entitled Injection Fitting, the entire content of which is incorporated herein by reference.

### BACKGROUND

### 1. Technical Field

Exemplary embodiments of the present disclosure relate to fluid systems, and more specifically, to injection fittings for introducing lubricant-sealants into valves of the fluid systems.

### 2. The Relevant Technology

As hydrocarbon production, conveyance, and distribution infrastructure ages, flow control equipment (e.g., flow control valves) is being used more often to achieve process flow isolation as unintended line breaks and the subsequent leaks may occur more often. Recently operators are introducing hydrogen into natural gas pipelines so as to safely convey hydrogen from where its generated to where it will be consumed. The blends in conventional systems are approaching 20% and some new systems are designed for one hundred percent hydrogen.

The sealants that flow control equipment (e.g., gate, ball, and plug valves) rely upon to achieve a seal once the equipment begins to underperform have changed to become more viscous and have a greater variety of entrained micronized polymers and other particulates to strive to achieve a temporary barrier for the in-line isolation. However, existing injection fittings used to introduce the sealants into the flow control equipment are not designed for the modified sealants and experience premature clogging that prevents the sealants to enter the flow control equipment.

Accordingly, there remains a need for improvement for injection fittings.

### BRIEF SUMMARY

Exemplary embodiments of the present disclosure relate to injection fittings. For example, in one embodiment, an injection fitting includes a main body, a flow cylinder, a sealing element, and biasing element. The main body has a fluid passageway therethrough. The flow cylinder is configured to be selectively secured at least partially within the fluid passageway in the main body. The flow cylinder has a fluid passageway therethrough and one or more flow enhancement features. The sealing element is configured to selectively seal off the fluid passageway in the main body and is movable between a sealing position and an open position. The biasing element is configured to bias the sealing element towards the sealing position.

In another embodiment, an injection fitting includes a main body having a fluid passageway therethrough and a flow cylinder configured to be selectively secured at least partially within the fluid passageway in the main body. The flow cylinder has a fluid passageway therethrough, one or more flats on an outer surface thereof, and one or more windows or notches open between the fluid passageways in the main body and the flow cylinder. The injection fitting is configured to have fluid flow through the fluid passageway therein with the fluid being able to flow through the fluid passageway in the flow cylinder, through the windows, and between the flats and a surface of the fluid passageway in the main body.

In another example embodiment, an injection fitting includes a main body, a flow cylinder, a sealing element, and a biasing element. The main body has a fluid passageway therethrough. The flow cylinder is configured to be selectively secured at least partially within the fluid passageway in the main body while still allowing fluid to flow through the fluid passageway and past the flow cylinder. The sealing element is positioned within the fluid passageway and configured to selectively seal off the fluid passageway in the main body. The sealing element is movable between a sealing position and an open position. The biasing element is disposed at least partially between the flow cylinder and the sealing element and is configured to bias the sealing element towards the sealing position.

These and other objects and features of the present disclosure will become more fully apparent from the following description and appended claims, or may be learned by the practice of the disclosed embodiments as set forth hereinafter.

### BRIEF DESCRIPTION OF THE DRAWINGS

To further clarify the above and other advantages and features of the present disclosure, a more particular description will be rendered by reference to specific embodiments thereof which are illustrated in the appended drawings. It is appreciated that these drawings depict only typical embodiments and are therefore not to be considered limiting of its scope, nor are the drawings necessarily drawn to scale. The disclosure will be described and explained with additional specificity and detail through the use of the accompanying drawings in which:

FIG. 1 illustrates an injection fitting according to one example embodiment of the disclosure.

FIG. 2 illustrates an exploded view of the injection fitting of FIG. 1.

FIGS. 3A and 3B illustrate cross-sectional views of the injection fitting of FIGS. 1 and 2.

FIG. 4 illustrates an injection fitting according to another example embodiment of the disclosure.

FIG. 5 illustrates an exploded view of the injection fitting of FIG. 4.

FIGS. 6A and 6B illustrate cross-sectional views of the injection fitting of FIGS. 4 and 5.

FIG. 7 illustrates a perspective view of an example embodiment of a cylinder for use with an injection fitting of the present disclosure.

FIG. 8 illustrates a bottom perspective view of an example embodiment of a cap for use with an injection fitting of the present disclosure.

### DETAILED DESCRIPTION

Reference will now be made to the drawings to describe various aspects of exemplary embodiments of the disclosure. It is understood that the drawings are diagrammatic and schematic representations of such exemplary embodiments, and are not limiting of the present disclosure, nor are they necessarily drawn to scale. No inference should therefore be drawn from the drawings as to the dimensions of any embodiment or element. In the following description, numerous specific details are set forth in order to provide a thorough understanding of the present disclosure. It will be obvious, however, to one of ordinary skill in the art that the present disclosure may be practiced without these specific details.

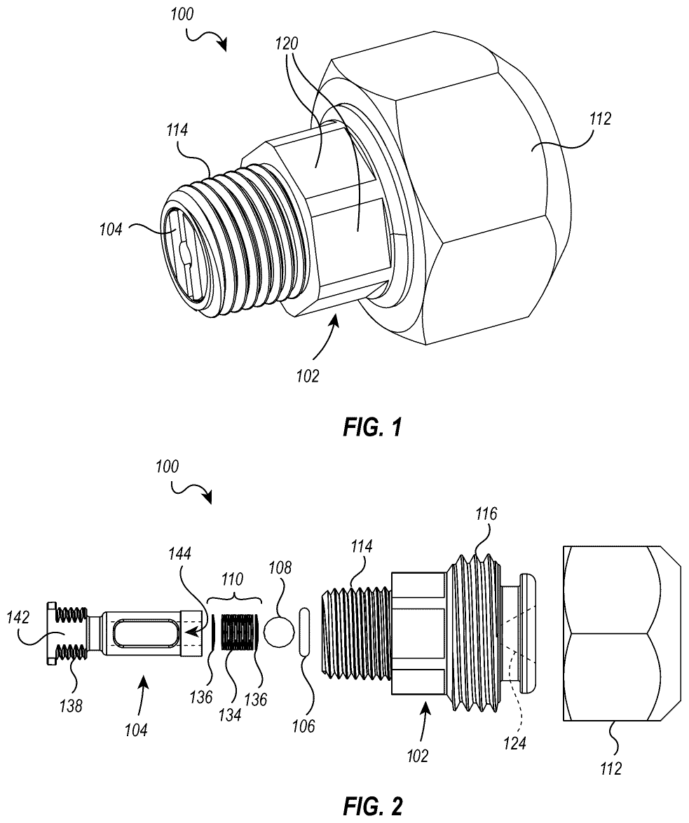

FIGS. 1-3B illustrate an injection fitting 100 according to one embodiment of the present disclosure. Generally, the injection fitting 100 includes a main body 102, a flow cylinder 104, a seal ring 106, a ball seal 108, a biasing assembly 110, and a cap 112. One end of the injection fitting 100 may be connected to flow control equipment (e.g., gate, ball, and plug valves) and a sealant may be injected through the injection fitting 100 and into the flow control equipment to seal leaks in the flow control equipment.

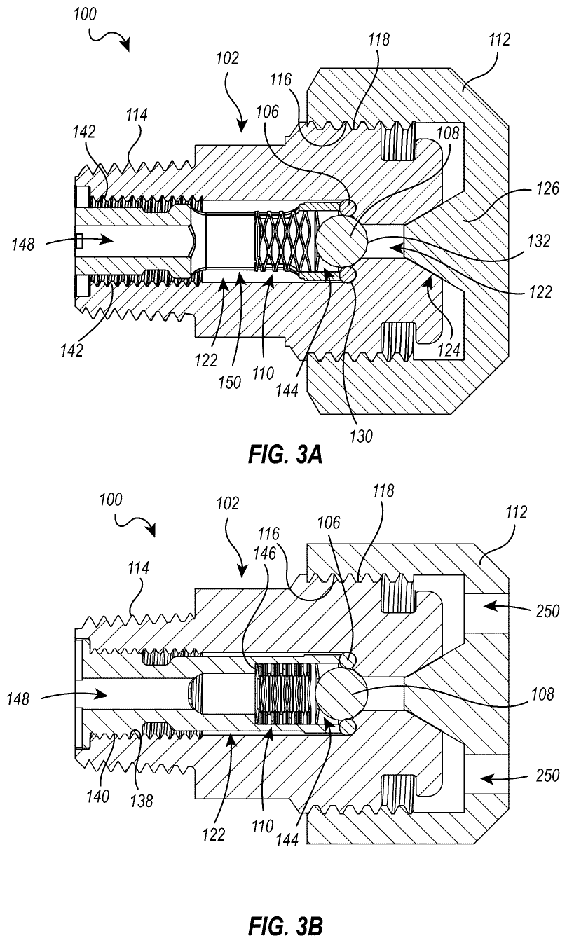

In the illustrated embodiment, the main body 102 includes external threads 114 on or adjacent to a first end thereof and external threads 116 on or adjacent to a second end thereof. The external threads 114 may facilitate connection of the injection fitting 100 to flow control equipment. The external threads 116 may mate with internal threads 118 in the cap 112 to secure the cap 112 onto the second end of the main body 102, as can be seen in FIGS. 3A and 3B. The main body 102 may also include one or more flats 120 that may be engaged by a wrench or other tool to facilitate rotation of the main body 102 (e.g., during installation or removal relative to flow control equipment).

The main body 102 also includes a fluid passageway 122 extending therethrough. The fluid passageway 122 includes a port 124 at the second end of the main body 102. The port 124 may be configured to receive at least partially therein a projection 126 on the interior of the cap 112. The port 124 and projection 126 may have mating or complimentary shapes and sizes, such that insertion of the projection 126 into the port 124 forms a seal that closes the port 124. In some embodiments, the cap 112 may also include a seal ring 128 disposed around the projection 126 (as shown in FIG. 8). The seal ring 128 may be configured to create a seal with the port 124.

Within the fluid passageway 122, the main body 102 may include a shoulder 130 against which the seal ring 106 may be positioned. Similarly, the fluid passageway 122 may also include a seal surface 132. The ball seal 108 may engage one or both of the seal ring 106 and the seal surface 132 to seal off the fluid passageway 122, thereby preventing the flow of fluid therethrough. In some embodiments, the ball seal 108 may initially engage the seal ring 106 and not the seal surface 132. Over time, however, the ring seal 106 may degrade or be moved out of position. In such cases, the ball seal 108 would then be able to engage the seal surface 132 to seal off the fluid passageway 122.

The ball seal 108 may be urged or biased into engagement with the ring seal 106 and/or the seal surface 132 by the biasing assembly 110 and the flow cylinder 104. More specifically, the ring seal 106 and the ball seal 108 may be inserted into the fluid passageway 122 through an opening in the first end of the main body 102. Thereafter, the biasing assembly 110 may be inserted followed by the flow cylinder 104, such that the biasing assembly 110 is disposed between the flow cylinder 104 and the ball seal 108. The flow cylinder 104 may be selectively secured within the fluid passageway 122 such that the flow cylinder 104 holds the biasing assembly 110 against the ball seal 108 and urges or biases the ball seal 108 into engagement with the ring seal 106 and/or the seal surface 108. In the illustrated embodiment, the biasing assembly 110 includes a stack of wave washers 134 and flat washers 136, although other types of biasing elements are contemplated herein.

As noted, the flow cylinder 104 is configured to be inserted and selectively secured in the fluid passageway 122. For instance, the flow cylinder 104 may include external threads 138 along a portion of the length thereof that mate with internal threads 140. Notably, as shown in FIGS. 2 and 3A, the external threads 138 extend only around portions of the circumference of the flow cylinder 104, thereby creating circumferentially offset sections of external threads 138. Between the sections of external threads 138 are flats 142. As will be discussed below, the flats 142 facilitate the flow of fluid through the injection fitting 100.

The flow cylinder 104 also includes a receptable 144 in an end thereof. As can be seen in FIGS. 3A and 3B, the receptable 144 is configured to receive the biasing assembly 110 at least partially therein. The receptable 144 may include a shoulder 146 to support the biasing assembly 110. The receptable 144 may also be sized and configured to receive at least a portion of the ball seal 108 therein.

A fluid passageway 148 extends through the flow cylinder 104. The flow cylinder 104 may also include one or more windows 150 in a sidewall thereof and which open to the fluid passageway 148. The portion of the flow cylinder 104 that includes the windows 150 may have a first cross-section dimension across the portion of the flow cylinder 104 that does not include the windows 150 (shown in FIG. 3B). The portion of the flow cylinder 104 that includes the windows 150 may also have a second cross-section dimension across the portion of the flow cylinder 104 that does include the windows 150 (shown in FIG. 3A). The second cross-sectional dimension may be smaller than the first cross-sectional dimension. This smaller dimension may create additional space between the windows 150 and the interior surface of the fluid passageway 122 in the main body 102. The additional space may facilitate the flow of fluid within the fluid passageway 122 into the fluid passageway 148 through the windows 150.

When the injection fitting 100 is assembled as shown in FIGS. 1-3B, fluid flow therethrough is prevented. Specifically, the seal formed between the ball seal 108 and the seal ring 106 and/or the seal surface 132 prevents fluid flow through the passageway 122. Additionally, the seal formed between the port 124 and the projection 126 in the cap 112 also prevents fluid flow. However, when it is desired to inject fluid through the injection fitting 100, the injection fitting 100 can be quickly and easily readied for fluid injection.

For instance, the cap 112 can be removed from the body 102 by unthreading the threads 118 from the threads 116. With the cap 112 removed, access to the port 124 is available. A fluid source (e.g., a source of sealant) may be associated with the main body 102. For instance, the fluid source may be threaded onto the threads 116 of the main body 102. The fluid source may then be pressurized to force the fluid into the main body 102 through the port 124.

The pressurized fluid may overcome the biasing force of the biasing assembly 110. As a result, the ball seal 108 may be pushed away from the ring seal 106 and/or seal surface 132. With the ball seal 108 so moved, the fluid may flow between the ball seal 108 and the ring seal 106 and/or seal surface 132. The fluid may continue to flow through the fluid passageway 148 in the flow cylinder 104. Additionally, the fluid may also flow through the fluid passageway 122 and around the exterior of the flow cylinder 104. This may include flowing around and through the windows 150 and between the flats 142 and the internal threads 138. The fluid may flow out of the injection fitting 100 through an opening in the end of the main body 102 (e.g., the same opening into which the flow cylinder 104 is inserted into the main body 102) and/or through one or more openings in an end of the flow cylinder 104.

In some embodiments, the biasing force of the biasing assembly 110 may be selectively adjusted. For instance, the flow cylinder 104 may be threadably inserted different distances into the fluid passageway 122. By inserting the flow cylinder 104 further into the fluid passageway 122, the biasing force can be increase (due to the increased compression of the biasing assembly 110). Alternatively, inserting the flow cylinder 104 not as far into the fluid passageway 122 may decrease the biasing force (due to less compression of the biasing assembly 110). Alternatively, the components of the biasing assembly may be selected to provide a desired biasing force.

When sufficient fluid has been injected through the injection fitting, the fluid source may be removed. This may include depressurizing the fluid and disconnecting from the main body 102. When the fluid is depressurized, the biasing force of the biasing assembly 110 will again bias or urge the ball seal 108 into engagement with the seal ring 106 and/or the seal surface 132, thereby sealing the injection fitting 100 and preventing the newly injected fluid from leaking out of the flow control equipment through the injection fitting 100.

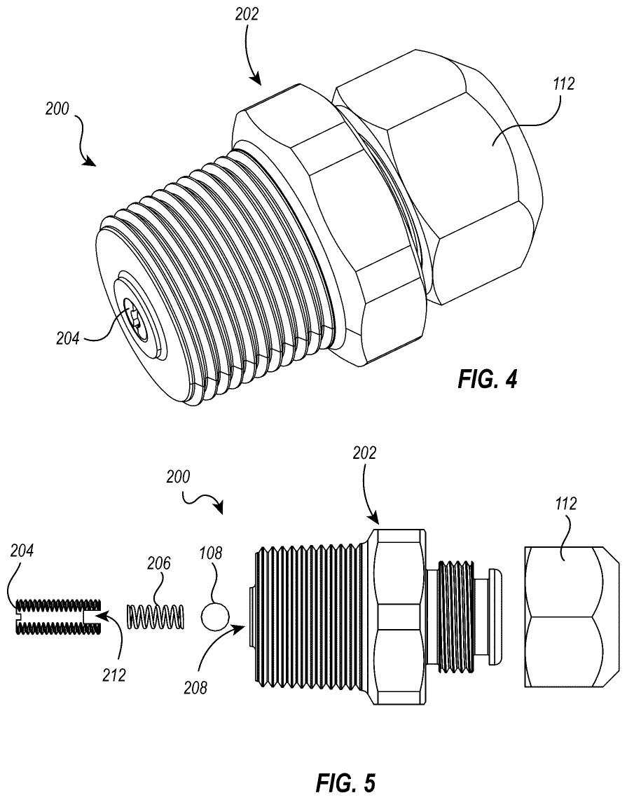

Attention is now directed to FIGS. 4-6B, which illustrate another embodiment of an injection fitting 200. Many aspects of the injection fitting 200 may be similar or identical to the injection fitting 100. Accordingly, the following discussion of the injection fitting 200 will focus primarily on those aspects that are different from the injection fitting 100. In describing the injection fitting 200, those aspects that are the same as or substantially similar to the corresponding aspects from the injection fitting 100 will be identified with the same reference numbers as from the injection fitting 100.

The injection fitting 200 includes a main body 202, a flow cylinder 204, a ball seal 108, a biasing member 206, and a cap 112. The main body 202 may include external threads on opposing ends thereof. The outer dimensions of the opposing ends of the main body may vary from one embodiment to another. Furthermore, the outer dimensions of the opposing ends of the main body may be the same as one another or may be different from one another.

As with the injection fitting 100, the main body 202 of the injection fitting 200 includes a fluid passageway 208 extending therethrough. The ball seal 108 may seal against a seal surface within the fluid passageway 208 as previously described. The cap 112 may selectively seal off a port in an end of the main body 202.

One distinction of the injection fitting 200 compared to the injection fitting 100 is the difference between the biasing assembly 110 and biasing member 206. While the biasing assembly 110 included a stack of wave washers and flat washers, the biasing member 206 is a coil spring. The coil spring biasing member 206 may be configured to engage the ball seal 108 and a portion of the flow cylinder 204 to urge or bias the ball seal 108 into engagement with the seal surface in the fluid passageway 208.

Another distinction between the injection fitting 200 compared to the injection fitting 100 is the configurations of the flow cylinders 104, 204. Similar to the flow cylinder 104, the flow cylinder 204 includes external threads on a portion thereof that can mate with threads within the fluid passageway 208. The flow cylinder 204 also has a fluid passageway 210 extending therethrough. The fluid passageway 210 includes a shoulder against which the biasing member 206 can be placed.

The flow cylinder 204 also includes one or more notches 212 therein. In the illustrated embodiment, the notches 212 extend through the sidewall of the flow cylinder and extend from a first end of the flow cylinder 204 towards a second end thereof. Additionally, the flow cylinder 204 also includes one or more flats 214 formed on an outer surface thereof and that run along the length thereof.

When fluid is injected through the injection fitting 200, the fluid may overcome the biasing force of the biasing member 206 and push the ball seal 108 away from the seal surface. The fluid may then flow between the ball seal 108 and the seal surface, around the ball seal, through the fluid passageway 208. The flow of fluid through the fluid passageway 208 may include flowing between the flats 214 and the interior surface of the fluid passageway 208. Additionally, the fluid may flow between the end of the flow cylinder 204 and the ball seal 108 and/or through the notches 212 into the fluid passageway 210 in the flow cylinder 210. When flowing between the end of the flow cylinder 204 and the ball seal 108 and/or through the notches 212 into the fluid passageway 210, the fluid may flow through the biasing member 206. The fluid may flow out of the injection fitting 200 through an opening in the end of the main body 202 (e.g., the same opening into which the flow cylinder 204 is inserted into the main body 202) and/or through one or more openings in an end of the flow cylinder 104.

When the fluid injection is completed, the flow of fluid through the injection fitting 200 may be turned off and the biasing member 206 may urge or bias the ball seal 108 back into sealing engagement with the seal surface to seal the fluid passageway 208. The cap 112 may then be replaced as discussed above.

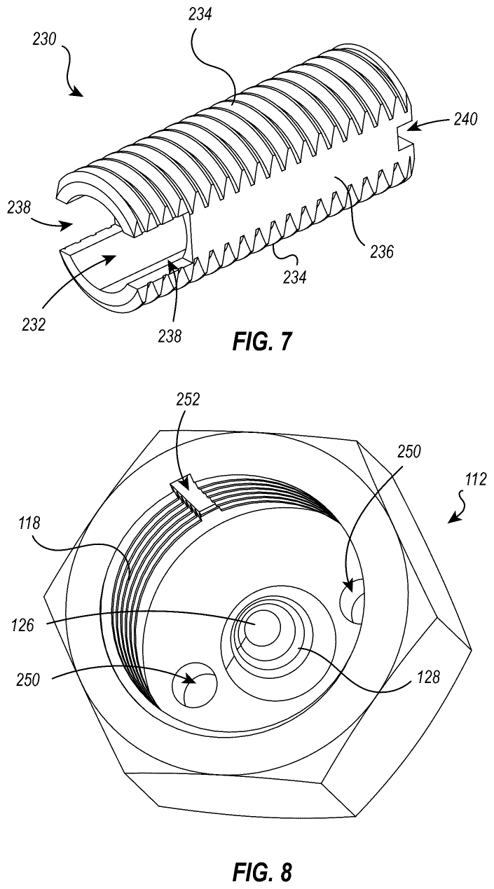

Attention is now directed to FIG. 7, which illustrates another embodiment of a flow cylinder 230. The flow cylinder 230 may be similar or identical to the flow cylinders 104, 204 in many respects. The flow cylinder 230 includes a fluid passageway 232 that extends therethrough. The flow cylinder may also include a shoulder to support a biasing member or assembly. Additionally, the flow cylinder 230 includes external threads 234 and one or more external flats 236. In the illustrated embodiment, the external threads 234 extend along the entire length of the flow cylinder 230. Similarly, the external flats 236 also extend along the entire length of the flow cylinder. Additionally, the flow cylinder 230 includes notches 238 similar or identical to the notches 212 discussed above. The fluid passageway 232, flats 236, and notches 238 facilitate the flow of fluid through and around the fluid cylinder 230.

The flow cylinder 230 also includes a rotation feature 240. The rotation feature 240 may be a slot or other receptable configured to receive a tool for rotating the flow cylinder 230 into or out of a main body of an injection fitting. The other flow cylinders disclosed herein may similarly include a rotation feature.

Attention is now directed to FIG. 8, which illustrates a perspective view of an interior of a cap 112. As noted above, the cap 112 may include internal threads 118 configured for threadably engaging the cap 112 to a main body of an injection fitting. The cap 112 also includes a projection 126 with a seal ring 128 as described above.

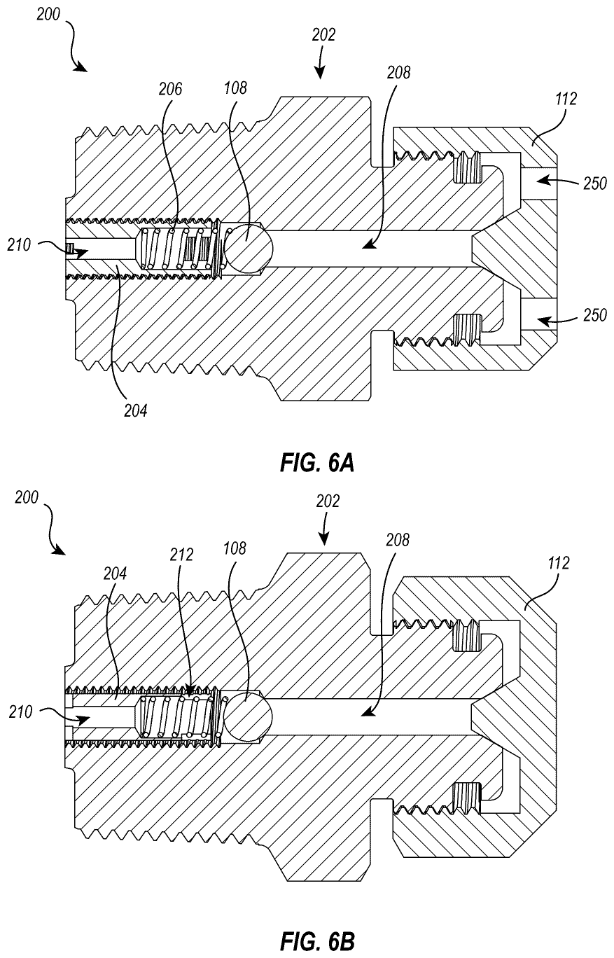

The cap 112 also includes pressure relief features. For instance, the cap 112 includes one or more apertures 250. The apertures 250 are also illustrated in FIGS. 3B and 6A. In the event that the seal formed with the ball seal 108/seal surface 132/seal ring 106 and/or the port 124/projection 126/seal ring 128 fails, pressure can be relived through the apertures 250. This may be desirable so that when the cap 112 is removed (e.g., to inject fluid through the injection fitting), there is not a buildup of high pressure within the injection fitting that could cause the cap 112 to fly off of the main body and potentially cause damage or injury.

The cap 112 can also include one or more relief channels 252. In the illustrated embodiment, the relief channel 252 extends across the internal threads 118 and forms a pathway for fluids or gases to exit the cap 112. Similar to the apertures 250, the relieve channel(s) can prevent a buildup of high pressure within the cap 112 in the event that the seals within the injection fitting should fail, thereby preventing the cap 112 from flying off the main body and potentially causing damage or injury. Notably, the relief channel(s) 252 exit the cap 112 in a direction that would be away from a user. As a result, when the cap 112 is being removed, any fluid or gas that exits the cap 112 through the relief channel(s) 252 would be directed away from the user, thereby further reducing the potential for injury.

Following are some further example embodiments of the invention. These are presented only by way of example and are not intended to limit the scope of the invention in any way. Further, any example embodiment can be combined with one or more of the example embodiments.

Embodiment 1. An injection fitting, comprising: a main body having a fluid passageway therethrough; a flow cylinder configured to be selectively secured at least partially within the fluid passageway in the main body, the flow cylinder having a fluid passageway therethrough and one or more flow enhancement features; a sealing element configured to selectively seal off the fluid passageway in the main body, the sealing element being movable between a sealing position and an open position; and a biasing element configured to bias the sealing element towards the sealing position.

Embodiment 2. An injection fitting as recited in embodiment 1, wherein the main body comprises a seal surface against which the sealing element is configured to be pressed.

Embodiment 3. An injection fitting as recited in embodiment 1 or 2, wherein the sealing element comprises a ball seal and/or a seal ring, and wherein the fluid passageway in the main body comprises a shoulder configured to support the seal ring and/or a seal surface configured to have the ball seal engaged therewith.

Embodiment 4. An injection fitting as recited in any of embodiments 1-3, wherein the one or more fluid enhancement features comprise one or more flats formed on an outer surface of the flow cylinder, the one or more flats being configured to enable fluid to flow between the one or more flats and an internal surface of the fluid passageway in the main body.

Embodiment 5. An injection fitting as recited in any of embodiments 1-4, wherein the one or more fluid enhancement features comprise one or more windows in a sidewall of the flow cylinder, the one or more windows opening into the fluid passageway in the flow cylinder.

Embodiment 6. An injection fitting as recited in any of embodiments 1-5, wherein the one or more fluid enhancement features comprise: one or more notches or windows formed in a sidewall of the flow cylinder, the one or more notches or windows opening between the fluid passageways in the flow cylinder and the main body.

Embodiment 7. An injection fitting as recited in any of embodiments 1-6, wherein further comprising a cap.

Embodiment 8. An injection fitting as recited in embodiment 7, wherein the cap comprises a sealing element that is configured to seal off a port in the main body.

Embodiment 9. An injection fitting as recited in embodiment 8, wherein the sealing element of the cap comprises a projection that is configured to extend at least partially into the port.

Embodiment 10. An injection fitting as recited in embodiment 9, wherein the sealing element of the cap comprises further comprises a seal ring disposed around the projection, the seal ring being configured to engage the port.

Embodiment 11. An injection fitting as recited in any of embodiments 7-10, wherein the cap further comprises one or more pressure relief features.

Embodiment 12. An injection fitting as recited in embodiment 11, wherein the pressure relief features comprise one or more apertures extending therethrough.

Embodiment 13. An injection fitting as recited in embodiment 11 or 12, wherein the pressure relief features comprise one or more relief channels, the one or more relief channels extending across internal threads within the cap.

Embodiment 14. An injection fitting, comprising: a main body having a fluid passageway therethrough; and a flow cylinder configured to be selectively secured at least partially within the fluid passageway in the main body, the flow cylinder having a fluid passageway therethrough, one or more flats on an outer surface thereof, and one or more windows or notches open between the fluid passageways in the main body and the flow cylinder, the injection fitting being configured to have fluid flow through the fluid passageway therein with the fluid being able to flow through the fluid passageway in the flow cylinder, through the windows, and between the flats and a surface of the fluid passageway in the main body.

Embodiment 15. An injection fitting as recited in embodiment 14, further comprising: a sealing element configured to selectively seal off the fluid passageway in the main body, the sealing element being movable between a sealing position and an open position; and a biasing element configured to bias the sealing element towards the sealing position.

Embodiment 16. An injection fitting as recited in embodiment 15, wherein the sealing element and the biasing element are positioned between the flow cylinder and a shoulder in the fluid passageway of the main body.

Embodiment 17. An injection fitting as recited in any of embodiments 14-16, wherein the main body comprises an injection port configured to enable fluid to be injected into the fluid passageway of the main body.

Embodiment 18. An injection fitting as recited in embodiment 17, further comprising a cap that is configured to be selectively secured to the main body and seal off the injection port.

Embodiment 19. An injection fitting, comprising: a main body having a fluid passageway therethrough; a flow cylinder configured to be selectively secured at least partially within the fluid passageway in the main body while still allowing fluid to flow through the fluid passageway and past the flow cylinder; a sealing element positioned within the fluid passageway and configured to selectively seal off the fluid passageway in the main body, the sealing element being movable between a sealing position and an open position; and a biasing element disposed at least partially between the flow cylinder and the sealing element and being configured to bias the sealing element towards the sealing position.

Embodiment 20. An injection fitting as recited in embodiment 19, wherein the flow cylinder comprises a fluid passageway therethrough, one or more flats on an outer surface thereof, and/or one or more windows or notches open between the fluid passageways in the main body and the flow cylinder.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An injection fitting, comprising:
a main body having a fluid passageway therethrough;
a flow cylinder configured to be selectively secured at least partially within the fluid passageway in the main body, the flow cylinder having a fluid passageway therethrough and one or more flow enhancement features;
a sealing element configured to selectively seal off the fluid passageway in the main body, the sealing element being movable between a sealing position and an open position; and
a biasing element configured to bias the sealing element towards the sealing position.

2. An injection fitting as recited in claim 1, wherein the main body comprises a seal surface against which the sealing element is configured to be pressed.

3. An injection fitting as recited in claim 1, wherein the sealing element comprises a ball seal and/or a seal ring, and wherein the fluid passageway in the main body comprises a shoulder configured to support the seal ring and/or a seal surface configured to have the ball seal engaged therewith.

4. An injection fitting as recited in claim 1, wherein the one or more fluid enhancement features comprise one or more flats formed on an outer surface of the flow cylinder, the one or more flats being configured to enable fluid to flow between the one or more flats and an internal surface of the fluid passageway in the main body.

5. An injection fitting as recited in claim 1, wherein the one or more fluid enhancement features comprise one or more windows in a sidewall of the flow cylinder, the one or more windows opening into the fluid passageway in the flow cylinder.

6. An injection fitting as recited in claim 1, wherein the one or more fluid enhancement features comprise:
one or more notches or windows formed in a sidewall of the flow cylinder, the one or more notches or windows opening between the fluid passageways in the flow cylinder and the main body.

7. An injection fitting as recited in claim 1, wherein further comprising a cap.

8. An injection fitting as recited in claim 7, wherein the cap comprises a sealing element that is configured to seal off a port in the main body.

9. An injection fitting as recited in claim 8, wherein the sealing element of the cap comprises a projection that is configured to extend at least partially into the port.

10. An injection fitting as recited in claim 9, wherein the sealing element of the cap comprises further comprises a seal ring disposed around the projection, the seal ring being configured to engage the port.

11. An injection fitting as recited in claim 7, wherein the cap further comprises one or more pressure relief features.

12. An injection fitting as recited in claim 11, wherein the pressure relief features comprise one or more apertures extending therethrough.

13. An injection fitting as recited in claim 11, wherein the pressure relief features comprise one or more relief channels, the one or more relief channels extending across internal threads within the cap.

14. An injection fitting, comprising:
a main body having a fluid passageway therethrough; and
a flow cylinder configured to be selectively secured at least partially within the fluid passageway in the main body, the flow cylinder having a fluid passageway therethrough, one or more flats on an outer surface thereof, and one or more windows or notches open between the fluid passageways in the main body and the flow cylinder,
the injection fitting being configured to have fluid flow through the fluid passageway therein with the fluid being able to flow through the fluid passageway in the flow cylinder, through the windows, and between the flats and a surface of the fluid passageway in the main body.

15. An injection fitting as recited in claim 14, further comprising:
a sealing element configured to selectively seal off the fluid passageway in the main body, the sealing element being movable between a sealing position and an open position; and
a biasing element configured to bias the sealing element towards the sealing position.

16. An injection fitting as recited in claim 15, wherein the sealing element and the biasing element are positioned between the flow cylinder and a shoulder in the fluid passageway of the main body.

17. An injection fitting as recited in claim 14, wherein the main body comprises an injection port configured to enable fluid to be injected into the fluid passageway of the main body.

18. An injection fitting as recited in claim 17, further comprising a cap that is configured to be selectively secured to the main body and seal off the injection port.

19. An injection fitting, comprising:
a main body having a fluid passageway therethrough;
a flow cylinder configured to be selectively secured at least partially within the fluid passageway in the main body while still allowing fluid to flow through the fluid passageway and past the flow cylinder;
a sealing element positioned within the fluid passageway and configured to selectively seal off the fluid passageway in the main body, the sealing element being movable between a sealing position and an open position; and
a biasing element disposed at least partially between the flow cylinder and the sealing element and being configured to bias the sealing element towards the sealing position.

20. An injection fitting as recited in claim 19, wherein the flow cylinder comprises a fluid passageway therethrough, one or more flats on an outer surface thereof, and/or one or more windows or notches open between the fluid passageways in the main body and the flow cylinder.
